(19) United States
(12) Patent Application Publication
(10) Pub. No.: US 2023/0395286 A1
(43) Pub. Date: Dec. 7, 2023

(54) CONSTRUCTION KIT, HYBRID CABLE CONSTRUCTION STRUCTURE, AND HYBRID CABLE CONSTRUCTION METHOD

(71) Applicant: NITTO DENKO CORPORATION, Osaka (JP)

(72) Inventor: Koichi TSUDA, 18250712 (JP)

(73) Assignee: NITTO DENKO CORPORATION, Osaka (JP)

(21) Appl. No.: 18/250,712

(22) PCT Filed: Oct. 27, 2021
(86) PCT No.: PCT/JP2021/039677

§ 371 Date: Apr. 26, 2023

(30) Foreign Application Priority Data
Oct. 28, 2020 (JP) 2020-180869

(51) Int. Cl. H01B 13/00; H01B 11/22

(52) U.S. Cl. CPC H01B 13/0036; H01B 11/22

(57) ABSTRACT

A construction kit is used for constructing a hybrid cable including an optical fiber, and a plurality of wires disposed in the circumferential direction around the optical fiber. Each of the wires includes a lead wire and a coating layer that coats the lead wire. The construction kit includes a first round hole into which the optical fiber can be inserted; a first member including receiving portions capable of receiving the wires, and a second member capable of being disposed outside the first member. A plurality of receiving portions is disposed in the circumferential direction around the first round hole. The second member is capable of pressurizing the wires toward the first round hole while the receiving portions receive the wires. The second member includes a plurality of pressure terminals having conductivity.

### TECHNICAL FIELD

The present invention relates to a construction kit, a hybrid cable construction structure, and a hybrid cable construction method.

### BACKGROUND ART

There is a known method for constructing a tip end portion of an optical/metal composite cable including an optical fiber core wire and a metal core wire (see, for example, Patent Document 1 below). The optical/metal composite cable described in Patent Document 1 includes one optical fiber core wire, and two metal core wires disposed on both left and right sides thereof. In Patent Document 1, first and second cutting blades are disposed on the lower sides of the two metal core wires, and these metal core wires are pressed against the respective cutting blades from their upper sides and then cut off.

### CITATION LIST

### Patent Document

Patent Document 1: Japanese Unexamined Patent Publication No. 2014-98806

### SUMMARY OF THE INVENTION

### Problem to be Solved by the Invention

In the optical/metal composite cable of Patent Document 1, however, both of the metal core wires receive pressure from their upper sides. Such pressure to the metal core wires is a force applied in one direction perpendicular to the right-and-left direction of the metal core wires and the optical fiber core wire. Therefore, both of the metal core wires are easily deformed on one side, that is, the same side (specifically, both on the lower side) in the perpendicular direction. This causes the metal core wires to be unevenly deformed. As a result, electrical connection reliability of the metal core wires is disadvantageously reduced.

The present invention provides a construction kit, a hybrid cable construction structure, and a hybrid cable construction method that suppress uneven deformation of a plurality of wires and provide excellent electrical connection reliability.

### Means for Solving the Problem

The present invention (1) includes a construction kit for connecting a hybrid cable including an optical fiber; and a plurality of wires disposed in a circumferential direction around the optical fiber, each including a lead wire and a coating layer that coats the lead wire, the construction kit including a first member comprising an insertion hole allowing the optical fiber to be inserted into the insertion hole, and a plurality of receiving portions disposed in a circumferential direction around the insertion hole, each capable of receiving the wire; and a second member capable of being disposed outside the first member, the second member including a plurality of pressure members having conductivity, the pressure members capable of pressurizing the wires toward the insertion hole while the receiving portions receives the wires.

In this construction kit, the plurality of receiving portions is disposed in the circumferential direction around the insertion hole. Therefore, the optical fiber is inserted into the insertion hole, the wires are received in the receiving portions, and the plurality of pressure members can be pressurized to the wires. Thus, the pressure to the optical fiber can be uniformly imparted to each of the wires. This can suppress uneven deformation between these wires. As a result of this, electrical connection reliability between the wire and the pressure member is excellent.

The present invention (2) includes the construction kit described in (1), in which the second member has an outer surface on which a first screw is formed, the construction kit further includes a third member capable of being disposed outside the second member, and the third member has an inner surface on which a second screw capable of being screwed to the first screw is formed.

In this construction kit, the first screw and the second screw can be screwed in. This allows the third member to tighten the second member from outside. Therefore, the plurality of pressure members can pressurize the plurality of wires with uniform force.

The present invention (3) includes the construction kit described in (1) or (2), in which the receiving portions are close to the insertion hole.

In this construction kit, since the receiving portions are close to the insertion hole, the first member can be miniaturized.

The present invention (4) includes the construction kit described in (1) or (2), in which the first member has a second insertion hole into which the wire can be inserted, the second insertion hole being disposed between the receiving portion and the insertion hole.

In this construction kit, the wire can be inserted into the second insertion hole. Therefore, the wire can be more surely held.

The present invention (5) includes a hybrid cable construction structure, including: a hybrid cable including an optical fiber, and a plurality of wires disposed in a circumferential direction around the optical fiber, each including a lead wire and a coating layer that coats the lead wire; and a construction kit as described in any one of (1) to (4), in which the optical fiber is inserted into the insertion hole, the wire is received in the receiving portion, and the lead wire is pressurized by the pressure member.

In this hybrid cable construction structure, the optical fiber is inserted into the insertion hole, the wire is received in the receiving portion, and the lead wire is pressurized by the pressure member. Thus, the pressure to the optical fiber can be uniformly imparted to each of the wires. This can suppress uneven deformation between these wires. As a result of this, electrical connection reliability between the wire and the pressure member is excellent.

The present invention (6) includes a hybrid cable construction method using a construction kit as described in any one of (1) to (4), the hybrid cable construction method including: a first step of laying the hybrid cable; a second step of exposing a peripheral surface of the optical fiber and peripheral surfaces of the wires at an end of the hybrid cable; a third step of inserting the optical fiber into the insertion hole and receiving the wires in the respective receiving portions; and a fourth step of pressurizing the wires toward the optical fiber by the pressure members.

According to the hybrid cable construction method, in the third step, the optical fiber is inserted into the insertion hole, and the wires are received in the respective receiving portions; and in the fourth step, the wires are pressurized toward the optical fiber by the pressure members. Therefore, the pressure to the optical fiber can be uniformly imparted to each of the wires. This can suppress uneven deformation between these wires. As a result of this, electrical connection reliability between the wire and the pressure member is excellent.

### Effects of the Invention

The construction kit, hybrid cable construction structure, and hybrid cable construction method according to the present invention suppress uneven deformation of the plurality of wires and provide excellent electrical connection reliability.

### BRIEF DESCRIPTION OF THE DRAWINGS

FIGS. 1A to 1D are cross sectional views of steps illustrating a first embodiment of a construction method according to the present invention: FIG. 1A represents a first step and a second step, FIG. 1B represents a third step, FIG. 1C represents a step of cutting an optical fiber and wires, and FIG. 1D represents a step of assembling a second member to a third member.

FIG. 2 represents a fourth step subsequent to FIG. 1D, and is a sectional view along a longitudinal direction of a construction structure of the first embodiment.

FIG. 3 is a perpendicular cross-sectional view of a first member.

FIG. 4 illustrates the first member viewed from the other side in the longitudinal side.

FIGS. 5A and 5B are perpendicular cross-sectional views of steps: FIG. 5A represents the third step, and FIG. 5B represents the fourth step.

FIG. 6 is a perpendicular cross-sectional view of a construction structure of the first member.

FIGS. 7A to 7C are perpendicular cross-sectional views of variations of the construction structure: FIG. 7A illustrates a variation having three receiving portions, FIG. 7B illustrates a variation having two receiving portions, and FIG. 7C illustrates a variation having eight receiving portions.

FIGS. 8A and 8B are perpendicular cross-sectional views of variations of the receiving portion: FIG. 8A illustrates a variation in which the receiving portion does not have a second recessed portion, and FIG. 8B illustrates a variation in which the receiving portion has a generally triangular shape.

FIGS. 9A to 9D are cross sectional views of steps illustrating a second embodiment of the construction method according to the present invention: FIG. 9A represents a first step and a second step, FIG. 9B represents a step of inserting the optical fiber into a first round hole and inserting the wires into second insertion holes, FIG. 9C represents a third step, and FIG. 9D represents a fourth step.

FIG. 10 is a perpendicular cross-sectional view of a first member of the second embodiment.

FIG. 11 is a perpendicular cross-sectional view of a ferrule of the second embodiment.

FIG. 12 is a perpendicular cross-sectional view of the third step.

FIG. 13 is a perpendicular cross-sectional view of a construction structure of the second embodiment.

### DESCRIPTION OF THE EMBODIMENTS

### First Embodiment

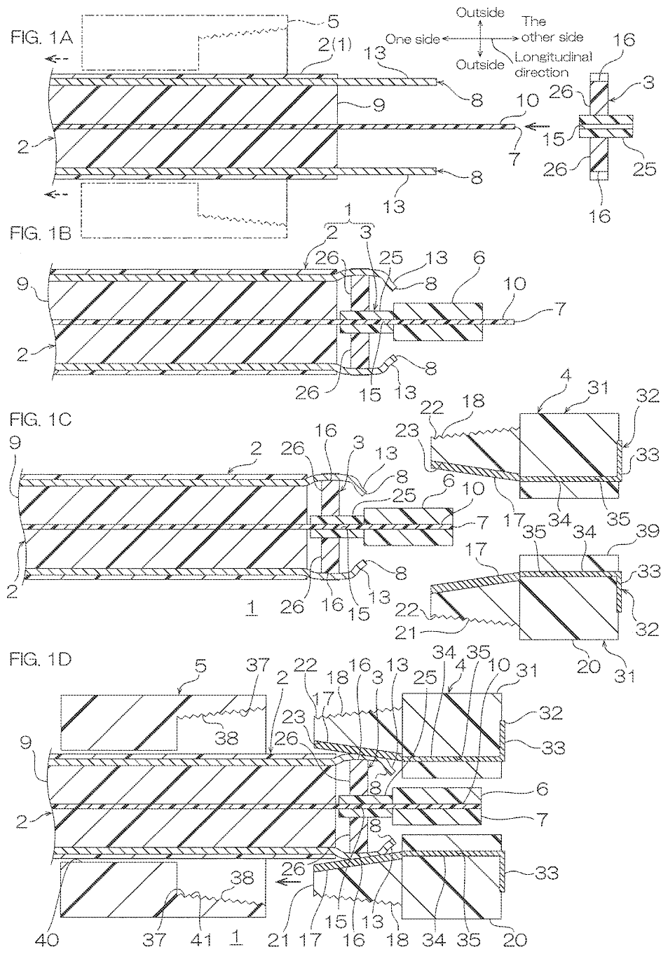

A first embodiment of a construction kit, a hybrid cable construction structure, and a hybrid cable construction method according to the present invention will be described with reference to FIGS. 1 to 6.

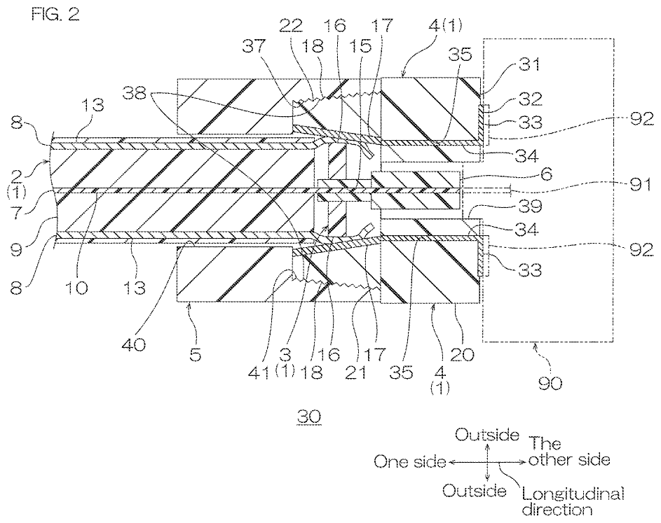

As shown in FIGS. 1C and 2, a construction kit 1 is used to construct a construction structure 30 of a hybrid cable 2 and to connect the construction structure 30 to an external module 90 (in phantom lines).

As shown in FIG. 1A, the hybrid cable 2 extends in a longitudinal direction. The hybrid cable 2 transmits an optical signal and an electrical signal in the longitudinal direction. The hybrid cable 2 has a generally circular shape in cross section perpendicular to the longitudinal direction. The hybrid cable 2 includes an optical fiber 7, at least one wire 8, and a sheath 9.

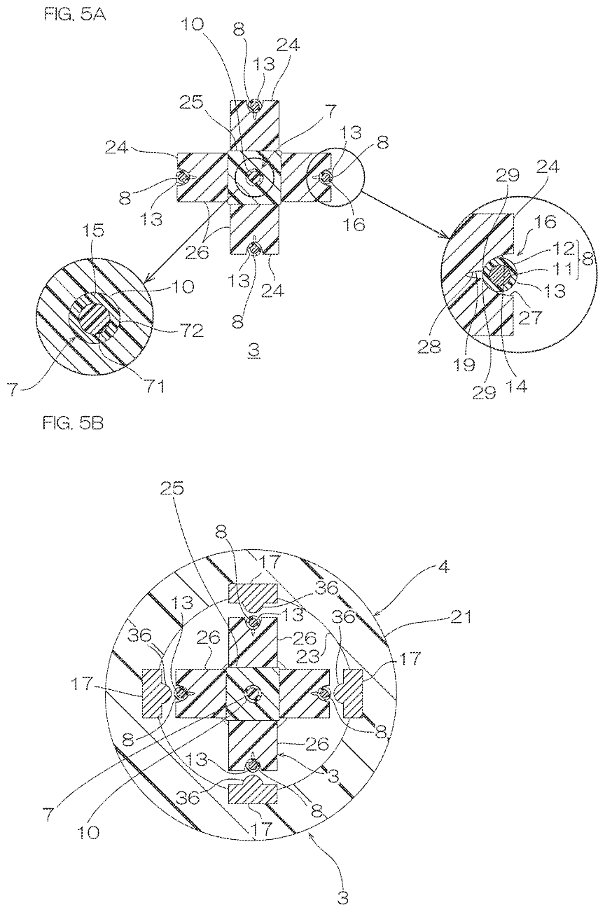

The optical fiber 7 extends in the longitudinal direction. The optical fiber 7 transmits an optical signal. As shown in FIG. 5A, the optical fiber 7 has, for example, a generally circular shape in perpendicular cross-section. The optical fiber 7 includes a fiber periphery The fiber periphery 10 is an outer peripheral surface of the optical fiber 7. The term “outside” refers to a side from a core 71 toward a clad 72. The term “inside” refers to the opposite side of the outside. Hereinafter, the inner side and the outer side follow the above-described definitions. The optical fiber 7 includes the core 71, and the clad 72 disposed on its peripheral surface. The core 71 has a higher refractive index than the clad 72. Examples of a material of the optical fiber 7 include resin and ceramics. Examples of the resin include acrylic resin and epoxy resin. Examples of the ceramics include glass. As the material of the optical fiber 7, for flexibility, resin is preferably used. In this case, the optical fiber 7 is referred to as a plastic optical fiber (POF). The size of the optical fiber 7 is not particularly limited. The optical fiber 7 has a diameter of, for example, 100 μm or more, and for example, 1000 μm or less.

A plurality of wires 8 is disposed in a circumferential direction around the optical fiber 7. The plurality of wires 8 extends in the longitudinal direction and is parallel to the optical fiber 7. These wires 8 transmit electrical signals. The wires 8 each have a generally circular shape in perpendicular cross-section. Each of the wires 8 includes a lead wire 11 and a coating layer 12.

The lead wire 11 has a generally circular shape in perpendicular cross-section. The lead wire 11 has conductivity. Examples of a material of the lead wire 11 include copper, silver, gold, aluminum, nickel, and alloys thereof. As the material of the lead wire 11, copper is preferably used. The size of the lead wire 11 is not particularly limited. The lead wire 11 has a diameter of, for example, 100 μm or more, and for example, 500 μm or less.

The coating layer 12 is an insulating layer that protects the lead wire 11 from chemicals and water, and that suppresses a short circuit between the lead wire 11 and other members. The coating layer 12 is disposed on the peripheral surface of the lead wire 11. The coating layer 12 has a generally annular shape in perpendicular cross-section. The coating layer 12 has a thickness of, for example, 50 μm or more, preferably 100 μm or more, and for example, 500 μm or less, preferably 300 μm or less. A ratio of the thickness of the coating layer 12 to the diameter of the lead wire 11 is, for example, 0.2 or more, preferably 0.4 or more, and for example, 1 or less, preferably 0.8 or less. When the thickness of the coating layer 12 and/or the ratio is/are the above-described upper limit(s) or less, a pressure terminal 17 can surely contact the lead wire 11 in a construction method to be described below. When the thickness of the coating layer 12 and/or the ratio is/are the above-described lower limit(s) or more, the lead wire 11 can be surely protected from chemicals and water, and a short circuit between the lead wire 11 and other members can be surely suppressed.

The wire 8 includes a wire periphery 13. The wire periphery 13 is an outer peripheral surface of the coating layer 12. The wire 8 has a diameter of, for example, 150 μm or more, and for example, 1000 μm or less.

As shown in FIG. 1A, the sheath 9 coats the fiber periphery 10 and the wire periphery 13. That is, the optical fiber 7 and the wires 8 are embedded in the sheath 9. The sheath 9 separates the optical fiber 7 from the plurality of wires 8. The sheath 9 also mutually separates the wires 8 that are arranged in the circumferential direction. The peripheral surface of the sheath 9 is a peripheral surface of the hybrid cable 2. The sheath 9 has a generally circular outer shape in perpendicular cross-section. Examples of a material of the sheath 9 include resin. Examples of the resin include polyolefin and polyvinyl chloride.

As shown in FIGS. 1C and 1D, the construction kit 1 includes a first member 3, a second member 4, and a third member 5.

As shown in FIG. 5A, the first member 3 has a generally cross shape in perpendicular cross-section. Examples of a material of the first member 3 include resin. Examples of the resin include polyimide resin and epoxy resin. The first member 3 integrally includes an insertion portion 25 and at least one protruding portion 26.

The insertion portion 25 is disposed at a generally center of the first member 3 in perpendicular cross-section. The insertion portion 25 extends in the longitudinal direction. The insertion portion 25 has a square cylindrical shape. The insertion portion 25 has a first round hole 15, which is an example of an insertion hole, inside. As shown in FIG. 1C, the first round hole 15 extends in the longitudinal direction. The first round hole 15 passes through the insertion portion 25 in the longitudinal direction. In this manner, the first round hole 15 allows the optical fiber 7 to be inserted thereinto.

As shown in FIG. 5A, the protruding portion 26 extends from each of (four) peripheral surfaces of the insertion portion 25 toward the outside in perpendicular cross-section. As shown in FIG. 1B, the (four) protruding portions 26 each have a generally rectangular shape in perpendicular cross-section. In the cross section along the longitudinal direction, the protruding portion 26 has a smaller length in the longitudinal direction than the insertion portion 25. As shown in FIG. 5A, a protruding outer surface 24, which is an example of the outer surface of the protruding portion 26 in perpendicular cross-section, has at least one receiving portion 16. The protruding outer surface 24 is a protruding side surface of the protruding portion 26. The protruding outer surface 24 is disposed on the side opposite to the first round hole 15 relative to the peripheral surface of the insertion portion 25.

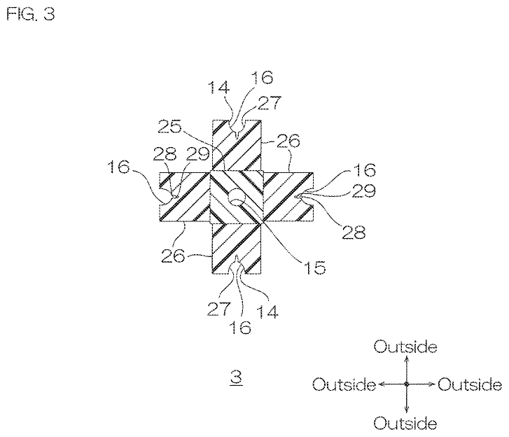

As shown in FIGS. 3 and 5A, a plurality of receiving portions 16 is disposed in the circumferential direction around the first round hole 15. Each of the receiving portions 16 has a first recessed portion 27 and a second recessed portion 28.

The first recessed portion 27 is recessed toward the insertion portion 25. The first recessed portion 27 has a first bottom surface 14 having a generally semicircular arc shape in perpendicular cross-section. The semicircular arc includes a semielliptical arc. The major axis of the ellipse that forms the semi-ellipse lies along, for example, a facing direction in which the insertion portion 25 faces the protruding portion 26 (an inside-outside direction around the first round hole 15) (radial direction), or a direction perpendicular to the facing direction (the circumferential direction around the first round hole 15). The major axis preferably lies along the facing direction (radial direction). A ratio of the diameter of the circular arc to the diameter of the optical fiber 7 or a ratio of the length of the major axis of the ellipse to the diameter of the optical fiber 7 is, for example, 0.5 or more and 2 or less.

The second recessed portion 28 is continuous with the first recessed portion 27. This allows a space partitioned by the second recessed portion 28 to communicate with a space partitioned by the first recessed portion 27. The second recessed portion 28 is provided, for example, at the deepest part of the first bottom surface 14. The second recessed portion 28 is recessed toward the insertion portion 25. The second recessed portion 28 has a second bottom surface 19 in perpendicular cross-section. The second bottom surface 19 includes, for example, a generally triangular shape and a semielliptical arc shape. The major axis of the ellipse lies along, for example, the facing direction in which the insertion portion 25 faces the protruding portion 26. Two ends of the second bottom surface 19 and the first bottom surface 14 are used to form a tapered portion 29. The tapered portion 29 is a ridgeline between the second bottom surface 19 and the first bottom surface 14.

Two tapered portions 29 are provided in one receiving portion 16. Each of the tapered portions 29 is tapered toward the space partitioned by the first recessed portion 27.

The receiving portion 16 is close to the first round hole 15. Specifically, a distance between the receiving portion 16 and the first round hole 15 is, for example, 10 mm or less, preferably 5 mm or less and, for example, 1 mm or more.

The second member 4 shown in FIG. 1C may be referred to as a connector housing. The second member 4 includes an insulating member 31 and at least one conductive member 32.

The insulating member 31 has a generally cylindrical shape extending in the longitudinal direction. Examples of a material of the insulating member 31 include insulating resin. Examples of the insulating resin include polyimide resin. The insulating member 31 integrally includes a support 20 and a pressure portion 21. The support 20 is a straight tube extending in the longitudinal direction. The support 20 has a second round hole 39 that has a common axis with the support 20. Further, the support 20 has a plurality of (four) via holes 35. These via holes 35 lie along the longitudinal direction.

The pressure portion 21 is continuous with one end face in the longitudinal direction of the support 20. The pressure portion 21 is a cylindrical tube extending in the longitudinal direction. Specifically, the pressure portion 21 extends from a radially intermediate portion on one end face in the longitudinal direction of the support 20 toward one side in the longitudinal direction. The outer diameter of the pressure portion 21 becomes smaller toward one side in the longitudinal direction. The inner diameter of the pressure portion 21 becomes larger toward one side in the longitudinal direction. Therefore, the perpendicular cross-sectional area of the pressure portion 21 becomes smaller toward one side in the longitudinal direction. A first screw 18 is formed on a pressure outer surface 22 which is an example of the outer surface of the pressure portion 21. The pressure outer surface 22 is an outer side surface of the pressure portion 21.

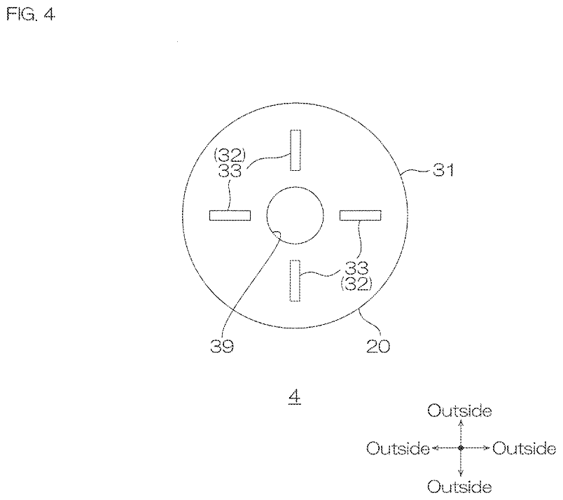

As shown in FIGS. 1C and 4, a plurality of (four) conductive members 32 is provided corresponding to the plurality of via holes 35. Each of these conductive members 32 electrically connects between the wire 8 and the external module 90 (in phantom lines in FIG. 2). Examples of a material of the conductive member 32 include copper, silver, gold, aluminum, nickel, and alloys thereof. As the material of the conductive member 32, copper is preferably used. Each of the conductive members 32 integrally has the pressure terminal 17 as an example of a pressure member, a terminal 33, and a communication portion 34.

As shown in FIGS. 1C and 5B, the pressure terminal 17 is disposed on a pressure inner surface 23 which is an example of the inner surface of the pressure portion 21. The pressure inner surface 23 is an inner side surface of the pressure portion 21. The pressure terminal 17 has a strip shape along the pressure inner surface 23. The pressure terminal 17 has a generally plate shape that is thin in the inside-outside direction, in perpendicular cross-section. The pressure terminal 17 includes an indenter 36.

The indenter 36 is provided on the inner surface of the pressure terminal 17. The indenter 36 has a generally semicircular shape bulging toward the inside in perpendicular cross-section. A ratio of the diameter of the circle of the indenter 36 to the diameter of the circle of the first recessed portion 27 of the first member 3 or a ratio of the diameter of the circle of the indenter 36 to the major axis of the ellipse of the first recessed portion 27 of the first member 3 is, for example, 0.9 or more and, for example, 1.5 or less.

As shown in FIGS. 1C and 4, the terminal 33 is disposed on the other end face in the longitudinal direction of the support 20 in the insulating member 31. The terminal 33 has a generally rectangular shape that is long in the inside-outside direction, when viewed from the other side in the longitudinal direction. The terminal 33 extends from the inside to the outside of the support 20.

As shown in FIG. 1C, the communication portion 34 communicates between the pressure terminal 17 and the terminal 33. The inside of the via hole 35 is charged with the communication portion 34. The communication portion 34 is continuous with the other end in the longitudinal direction of the pressure terminal 17 and the inner end of the conductive member 32. The communication portion 34 electrically connects between the pressure terminal 17 and the conductive member 32.

The third member 5 shown in FIGS. 1D and 2 is referred to as a boot. The third member 5 extends in the longitudinal direction. The third member 5 has a generally cylindrical shape. The third member 5 has a third round hole 40 that has a common axis with the third member 5. The third member 5 further has a screw hole 41. The axis of the screw hole 41 is in common with the axis of the third member 5. The screw hole 41 is disposed at the other end in the longitudinal direction of the third round hole 40 and has an expanded diameter larger than the diameter of the third round hole 40. The opening cross-sectional area of the screw hole 41 becomes smaller toward one side in the longitudinal direction. The screw hole 41 is partitioned by a second inner surface 37 at the other end in the longitudinal direction of the third member 5. The second inner surface 37 faces the screw hole 41. A second screw 38 is formed on the second inner surface 37. The second screw 38 is capable of being screwed to the first screw 18 of the second member 4. In the third member 5, as the screwing of the second screw 38 to the first screw 18 progresses, the second inner surface 37 can pressurize the pressure portion 21 toward the inside. The third member 5 is harder than the second member 4. Examples of a material of the third member 5 include hard material. Examples of the hard material include hard resin and metal.

Next, a construction method for constructing the hybrid cable 2 using the construction kit 1 will be described. This construction method includes a first step, a second step, a third step, and a fourth step. In this construction method, the first step, the second step, the third step, and the fourth step are sequentially performed.

In the first step, the hybrid cable 2 shown in FIG. 1A is laid. Specifically, one end in the longitudinal direction of the hybrid cable 2 is allowed to pass through a narrow space. Examples of the narrow space include a space in piping, a rear wall space, and an underfloor space.

Thereafter, the hybrid cable 2 is inserted into the third round hole 40 and the screw hole 41 of the third member 5 as indicated in phantom lines in FIG. 1A. Then, as indicated in phantom lines in FIG. 1A, the third member 5 is moved from the other end in the longitudinal direction of the hybrid cable 2 to one side thereof.

As shown in FIG. 1A, in the second step, the sheath 9 is removed from the other end in the longitudinal direction of the hybrid cable 2. This exposes the fiber periphery 10 of the optical fiber 7 and the wire peripheries 13 of the wires 8 from the sheath 9.

As shown in FIGS. 1B and 5A, in the third step, the optical fiber 7 is inserted into the first round hole 15. Specifically, the other end in the longitudinal direction of the optical fiber 7 is inserted into the first round hole 15 and is then inserted into the ferrule 6 as well. The ferrule 6 has a cylindrical shape along the longitudinal direction. The other end in the longitudinal direction of the optical fiber 7 is exposed from the other end face in the longitudinal direction of the ferrule 6.

With the insertion of the optical fiber 7 into the first round hole 15, the plurality of wires 8 is received in the plurality of receiving portions 16, respectively. Specifically, some longitudinal midpoint in the other end in the longitudinal direction of the wire 8 is fitted (buried) in the first recessed portion 27 of the receiving portion 16. For more details, the wire periphery 13 is brought into contact with the first bottom surface 14.

Thereafter, the other end in the longitudinal direction of the optical fiber 7 and the other end faces in the longitudinal direction of the wires 8 are cut and removed.

Specifically, the other end in the longitudinal direction of the optical fiber 7 that is disposed on the other side in the longitudinal direction from the ferrule 6 is cut. This allows the other end face in the longitudinal direction of the optical fiber 7 to be flush with the other end face in the longitudinal direction of the ferrule 6.

In addition, a redundant portion of the other end in the longitudinal direction of the wire 8 that is disposed on the other side in the longitudinal direction from the receiving portion 16 is cut. However, the other end face in the longitudinal direction of the wire 8 thus cut is still disposed on the other side in the longitudinal direction from the receiving portion 16.

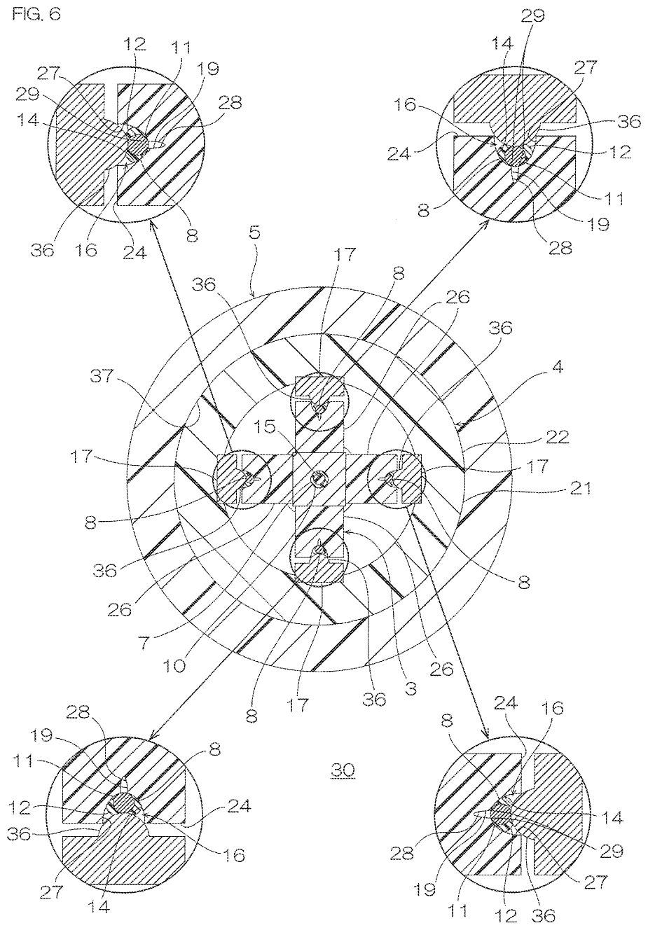

Next, as shown in FIGS. 2 and 6, in the fourth step, the plurality of pressure terminals 17 pressurizes the plurality of wires 8, respectively, toward the optical fiber 7 (first round hole 15).

Specifically, first, as shown in the right-side figure of FIG. 1C, the second member 4 is disposed on the other side in the longitudinal direction of the first member 3. Specifically, the second member 4 is disposed on the other side in the longitudinal direction of the first member 3 so that the second round hole 39 includes the insertion portion 25 and the ferrule 6 when projected in the longitudinal direction. As shown in FIG. 5B, when projected in the longitudinal direction, the plurality of indenters 36 is faced to the plurality of wires 8 respectively in the inside-outside direction. For example, on the plane of projection in the longitudinal direction, a circle center of the indenter 36 is present on an extension obtained by extending a line segment connecting between the axis of the optical fiber 7 and the axis of the wire 8.

Subsequently, as shown in FIG. 1D, the second member 4 is moved to one side in the longitudinal direction. This brings the inner surface of the indenter 36 into contact with the outside portion of the wire periphery 13 of the wire 8.

Thereafter, as shown in FIG. 2, the first screw 18 of the second member 4 and the second screw 38 of the third member 5 are screwed in. Specifically, the third member 5 is rotated relative to the second member 4 in the circumferential direction. This allows the pressure portion 21 of the second member 4 to be inserted deeper into the screw hole 41 of the third member 5.

Then, as shown in FIG. 6, the pressure portion 21 is pressurized toward the inside by the third member 5. In this manner, the indenter 36 pressurizes the wire 8 toward the inside. This causes the outside portion of the coating layer 12 to be broken, and therefore, the inner surface of the indenter 36 contacts the outer surface of the lead wire 11. At this time, when the wire 8 pressurizes the receiving portion 16 based on the above-described pressurization, the inside portion of the wire 8 receives a reaction force from the tapered portion 29, the tapered portion 29 bites into the coating layer 12, and as a result, circumferential movement of the wire 8 is regulated. Due to the reaction force of the tapered portion 29, the inside portion of the coating layer 12 is also broken, and the tapered portion 29 may contact the inner surface of the wire 8.

In this manner, the plurality of lead wires 11 is electrically connected to the pressure terminals 17. Specifically, as shown in FIG. 2, an electrical path passing through the lead wire 11 of the wire 8 (see FIG. 5A), the pressure terminal 17, the communication portion 34, and the terminal 33 is formed. That is, the wire 8 is electrically connected to the conductive member 32. Thus, the other end in the longitudinal direction of the wire 8 in the hybrid cable 2 is constructed. By doing this, the construction structure 30 of the hybrid cable 2 is produced.

Thereafter, as shown in FIG. 2, the construction structure 30 is optically and electrically connected to the module 90 (in phantom lines). The module 90 includes a second optical fiber 91 and an electrode 92 on one end face in the longitudinal direction. The one end face in the longitudinal direction of the second optical fiber 91 is disposed so as to face the other end face in the longitudinal direction of the optical fiber 7. The electrode 92 is contacted with the terminal 33 from the other side in the longitudinal direction.

Thus, the construction structure 30 is optically and electrically connected to the module 90.

<Operations and Effects of First Embodiment>

In this construction kit 1, the plurality of receiving portions 16 is disposed in the circumferential direction around the first round hole 15. Therefore, the optical fiber 7 is inserted into the first round hole 15, the wires 8 are received in the receiving portions 16, and the plurality of pressure terminals 17 can be pressurized to the wires 8. For this reason, the pressure to the optical fiber 7, that is, the pressure to the inside (center of the construction structure 30) can be uniformly imparted to the plurality of wires 8. This can suppress uneven deformation between these wires 8. As a result of this, electrical connection reliability between the lead wire 11 and the pressure terminal 17 is excellent.

With this construction kit 1, the first screw 18 and the second screw 38 can be screwed in. This allows the third member 5 to tighten the second member 4 from outside. As a result of this, the plurality of pressure terminals 17 can pressurize the plurality of wires 8 with uniform force.

Further, in this construction kit 1, since the receiving portion 16 is close to the first round hole 15, the first member 3 can be miniaturized.

[Variations of First Embodiment]

In the following variations, the same reference numerals are provided for members and steps corresponding to each of those in the first embodiment described above, and their detailed description is omitted. Further, the variations can achieve the same operations and effects as those of the first embodiment unless otherwise specified. Furthermore, the first embodiment and the variations thereof can be appropriately used in combination.

In the first embodiment, the number of the receiving portions 16 is four. The number of the receiving portions 16 is not particularly limited as long as it is plural. The number thereof is, for example, 2 or 3, and is 5 or more.

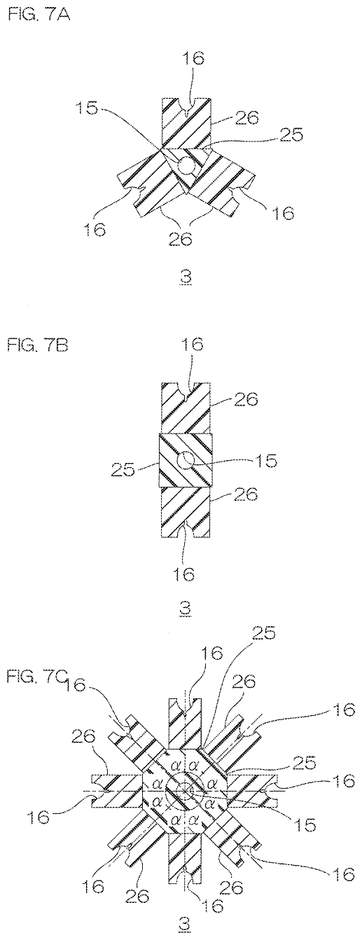

Specifically, as shown in FIG. 7A, the first member 3 includes three receiving portions 16. These three receiving portions 16 are each disposed at the apex of the triangle having a common center of gravity with the first round hole 15.

As shown in FIG. 7B, the first member 3 includes two receiving portions 16. In this variation, a line segment connecting between two receiving portions 16 passes through the first round hole 15.

As shown in FIG. 7C, the first member 3 includes eight receiving portions 16. In these eight receiving portions 16, circumferential angles a formed by line segments passing through two circumferentially adjacent receiving portions 16 and the first round hole 15 are almost identical to each other.

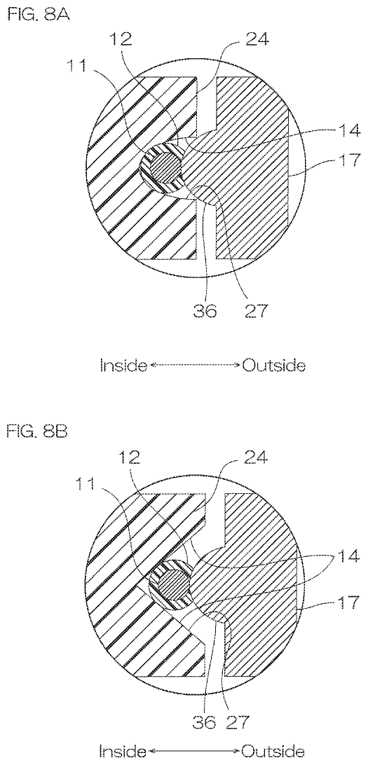

As shown in FIG. 8A, the receiving portion 16 does not include the second recessed portion 28 and may include only the first recessed portion 27. In this case, since the receiving portion 16 does not include the tapered portion 29, the inside portion of the coating layer 12 may not be broken.

As shown in FIG. 8B, the receiving portion 16 may have two inclined surfaces as the first bottom surface 14. These two inclined surfaces have a close facing distance toward the insertion portion 25 (inside). Thus, a triangular space is partitioned by the first recessed portion 27.

Though not shown, the ferrule 6 may not be provided in the construction structure 30.

### Second Embodiment

In the following second embodiment, the same reference numerals are provided for members and steps corresponding to each of those in the first embodiment described above, and their detailed description is omitted. Further, the second embodiment can achieve the same operations and effects as those of the first embodiment unless otherwise specified. Furthermore, the first embodiment, the second embodiment, and the variations thereof can be appropriately used in combination.

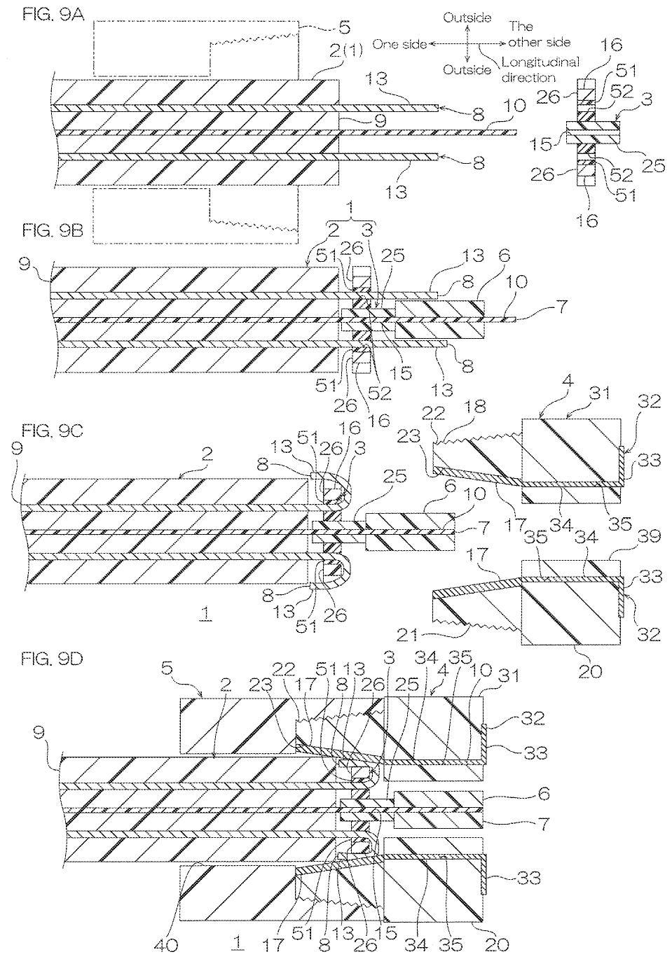

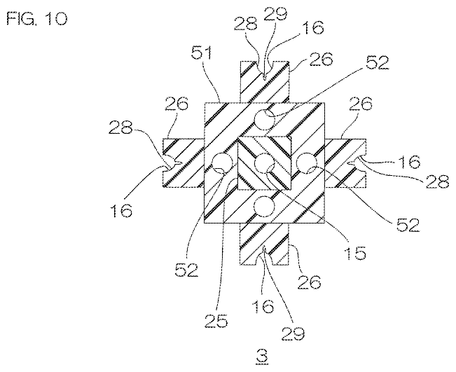

As shown in FIGS. 9A and 10, the first member 3 further includes a second insertion portion 51. The second insertion portion 51 surrounds the insertion portion 25 in perpendicular cross-section. The second insertion portion 51 has a generally rectangular frame shape in perpendicular cross-section. The second insertion portion 51 has a second insertion hole 52. The second insertion hole 52 is disposed in each of four side portions of the second insertion portion 51. Each of the four second insertion holes 52 is a through hole passing through the second insertion portion 51 in the longitudinal direction. These second insertion holes 52 each have a generally circular shape in perpendicular cross-section. The four second insertion holes 52 allow four wires 8 to be inserted thereinto, respectively.

Four protruding portions 26 are provided on four outer surfaces of the second insertion portion 51, respectively. Thus, the second insertion hole 52 is disposed between the receiving portion 16 and the first round hole 15. A distance between the receiving portion 16 and the first round hole 15 in the second embodiment is longer than that in the first embodiment. Specifically, the distance between the receiving portion 16 and the first round hole 15 in the second embodiment is, for example, 2 mm or more and, for example, 10 mm or less, preferably 7 mm or less.

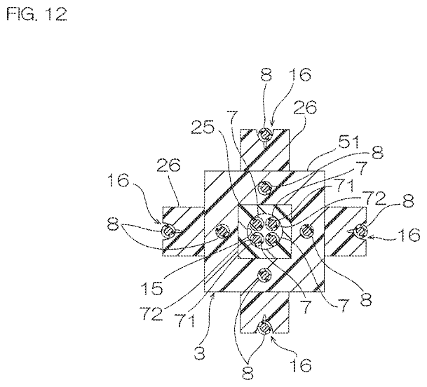

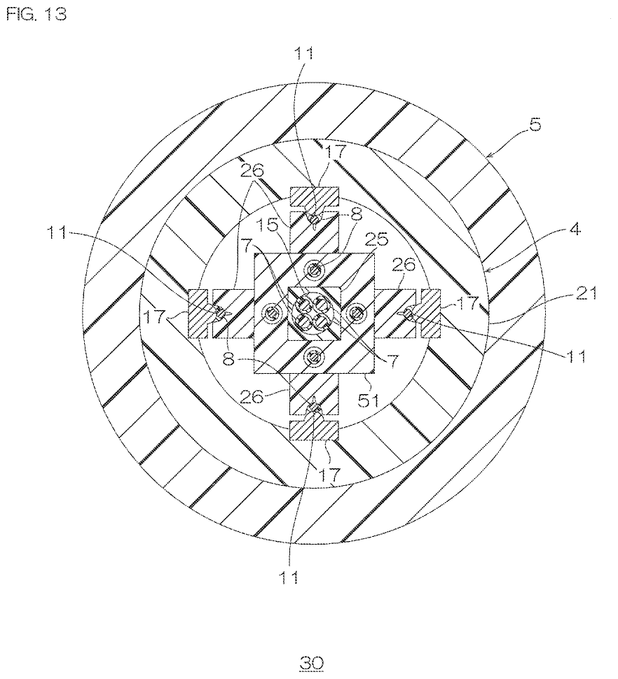

As shown in FIGS. 12 and 13, in the second embodiment, two or more optical fibers 7 are used. In this case, the optical fiber 7 is a so-called multi-core type optical fiber. These optical fibers 7 may be bonded to each other with resin (not shown) or the like.

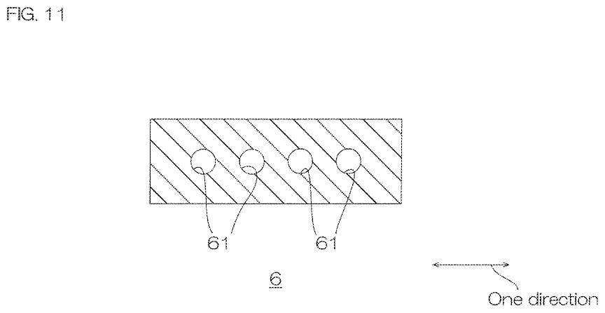

As shown in FIG. 11, the ferrule 6 has a plurality of through holes 61 into which those optical fibers 7 (see FIG. 12) can be inserted. These through holes 61 are arranged side by side in one direction. The one direction is included in the perpendicular direction. The ferrule 6 has a generally rectangular shape that is long in one direction in perpendicular cross- section.

A construction method for constructing the hybrid cable 2 using the construction kit 1 including the above-described first member 3, and the ferrule 6 will be described.

The first, second, and fourth steps are the same as those in the first embodiment.

In the third step, the plurality of optical fibers 7 is inserted into the first round hole 15. Subsequently, the tip end portions of the optical fibers 7 are branched into two or more portions, and these tip end portions thus branched are inserted into the plurality of through holes 61, respectively, in the ferrule 6 shown in FIG. 11.

As shown in FIG. 9B, in the third step, the tip end portions of the wires 8 are inserted into the respective second insertion holes 52. As shown in FIG. 9C, subsequently, the tip end portions of the wires 8 are folded back to one side in the longitudinal direction. Thereafter, the tip end portions of the wires 8 are received in the respective receiving portions 16.

Thereafter, the other end in the longitudinal direction of the optical fiber 7 is cut. In addition, a redundant portion of the wire 8 disposed on one side in the longitudinal direction from the receiving portion 16 is cut. <Operations and Effects of Second Embodiment>

With this construction kit 1, the wire 8 can be inserted into the second insertion hole 52. Therefore, the wire 8 can be more surely held, as compared with the first embodiment in which the wire 8 is not inserted into the second insertion hole 52.

In contrast, in the first embodiment, since the first member 3 does not have the second insertion hole 52 between the receiving portion 16 and the first round hole 15, the distance therebetween can be reduced. That is, the receiving portion 16 can be arranged close to the first round hole 15. Therefore, in the first embodiment, the first member 3 can be miniaturized, as compared with the second embodiment.

While the illustrative embodiments of the present invention are provided in the above description, such is for illustrative purpose only and it is not to be construed restrictively. Modification and variation of the present invention that will be obvious to those skilled in the art is to be covered by the following claims.

### INDUSTRIAL APPLICABILITY

The construction kit is used in the hybrid cable construction structure and construction method.

### DESCRIPTION OF REFERENCE NUMERALS

1 construction kit

2 hybrid cable

3 first member

4 second member

5 third member

7 optical fiber

8 wire

11 lead wire

12 coating layer

16 receiving portion

21 pressure portion

22 pressure outer surface

23 pressure inner surface

24 protruding outer surface

30 construction structure

37 second inner surface

52 second insertion hole

1. A construction kit for connecting a hybrid cable comprising an optical fiber; and a plurality of wires disposed in a circumferential direction around the optical fiber, each comprising a lead wire and a coating layer that coats the lead wire,
the construction kit comprising:
a first member comprising an insertion hole allowing the optical fiber to be inserted into the insertion hole, and a plurality of receiving portions disposed in a circumferential direction around the insertion hole, each capable of receiving the wire; and
a second member capable of being disposed outside the first member, the second member comprising a plurality of pressure members having conductivity, the pressure members capable of pressurizing the wires toward the insertion hole while the receiving portions receives the wires.

2. The construction kit according to claim 1, wherein
the second member has an outer surface on which a first screw is formed,
the construction kit further comprises a third member capable of being disposed outside the second member, and
the third member has an inner surface on which a second screw capable of being screwed to the first screw is formed.

3. The construction kit according to claim 1, wherein the receiving portions are close to the insertion hole.

4. The construction kit according to claim 1, wherein the first member has a second insertion hole into which the wire can be inserted, the second insertion hole being disposed between the receiving portion and the insertion hole.

5. A hybrid cable construction structure, comprising:
a hybrid cable comprising an optical fiber, and a plurality of wires disposed in a circumferential direction around the optical fiber, each comprising a lead wire and a coating layer that coats the lead wire; and
a construction kit as defined in claim 1, in which the optical fiber is inserted into the insertion hole, the wire is received in the receiving portion, and the lead wire is pressurized by the pressure member.

6. A hybrid cable construction method using a construction kit as defined in claim 1,
the hybrid cable construction method comprising:
a first step of laying the hybrid cable;
a second step of exposing a peripheral surface of the optical fiber and peripheral surfaces of the wires at an end of the hybrid cable;
a third step of inserting the optical fiber into the insertion hole and receiving the wires in the respective receiving portions; and
a fourth step of pressurizing the wires toward the optical fiber by the pressure members.
